(19) United States
(12) Patent Application Publication
(10) Pub. No.: US 2026/0038754 A1
(43) Pub. Date: Feb. 5, 2026

(54) SWITCH PANEL

(71) Applicant: Zhuhai Shengchang Electronics Co., Ltd., Zhuhai City (CN)

(72) Inventors: Jialong HU, Zhuhai City (CN); Dehua ZHENG, Zhuhai City (CN)

(73) Assignee: Zhuhai Shengchang Electronics Co., Ltd., Zhuhai City (CN)

(21) Appl. No.: 18/820,175

(22) Filed: Aug. 29, 2024

(30) Foreign Application Priority Data
Aug. 2, 2024 (CN) 2024110560499

(51) Int. Cl. H01H 23/24; H01H 23/08

(52) U.S. Cl. CPC H01H 23/24; H01H 23/08; H01H 2221/016

(57) ABSTRACT

Provided is a switch panel. A connecting base includes a first connecting arm, and a number of the first connecting arm is two; a reset assembly includes a swing piece, a connecting shaft and a reset piece; the swing piece includes a first swing portion and a second swing portion, the first swing portion is arranged between the two first connecting arms and is provided with a strip-shaped through hole extending towards the second swing portion, and the second swing portion is arranged at an end of the first swing portion away from another reset assembly; the connecting shaft rotatably penetrates through the strip-shaped through hole and is connected between the two first connecting arms, the reset piece is sleeved outside the first swing portion, and two ends of the reset piece are pre-compressed to abut against a position between the connecting shaft and the second swing portion.

### TECHNICAL FIELD

The present disclosure relates to the technical field of push switches, and in particular to a switch panel.

### BACKGROUND

At present, reset components of switch panels are usually arranged in a vertical layout or horizontally symmetrical layout, which makes the size of the switch panel too large in a certain direction, leading to poor dimensional balance of the switch panel and further restricting its use.

### SUMMARY

In order to overcome the shortcomings of the prior art, the object of the present disclosure is to provide a switch panel that is conducive to improving the balance of size in all directions, thereby enhancing the flexibility of its use.

In order to solve the above problems, the technical solutions adopted by the present disclosure are as follows:
a switch panel, comprising a mounting base, and the switch panel further comprising:
a key piece, wherein the key piece is provided with a key portion, a number of the key portion is two, and the key piece is rotatably connected to the mounting base, so that the key portion is arranged to be tilted or lowered relative to another key portion;
a connecting base, a number of the connecting base is two, wherein each connecting base is convexly arranged on the key portion relative to the mounting base, and the connecting base includes a first connecting arm, and a number of the first connecting arm is two, both of which are arranged spaced apart;
a reset assembly, a number of the reset assembly is two, wherein the reset assembly includes a swing piece, a connecting shaft and a reset piece, the swing piece includes a first swing portion and a second swing portion, the first swing portion is arranged between the two first connecting arms, the second swing portion is arranged at an end of the first swing portion away from another reset assembly, the first swing portion is provided with a strip-shaped through hole extending towards the second swing portion, the connecting shaft rotatably penetrates through the strip-shaped through hole and is connected between the two first connecting arms, the reset piece is sleeved outside the first swing portion, and two ends of the reset piece are pre-compressed to abut against a position between the connecting shaft and the second swing portion; and
a limiting piece, a number of the limiting piece is two, wherein the limiting piece includes a first limiting portion and a second limiting portion; and observed along a rotation direction of the key piece, the first limiting portion is connected between the mounting base and the second limiting portion, which are spaced apart, to jointly form a limiting space, and the second swing portion of each reset assembly is rotatably limited in the limiting space.

In some possible embodiments, the second swing portion is provided with a first arc-shaped end face bent away from the first swing portion, an end face of the first limiting portion relative to the limiting space is provided with a first arc-shaped area, the first arc-shaped area is adjacent to the mounting base, the second limiting portion is provided with a second arc-shaped end face arranged relative to the limiting space, and bending degrees of the first arc-shaped area and the second arc-shaped end face are matched with a bending degree of the first arc-shaped end face.

In some possible embodiments, the first limiting portion is provided with a first arc-shaped area, and a number of the first arc-shaped area is two, both of which are arranged spaced apart, and a projection of the second limiting portion is located between the two first arc-shaped areas.

In some possible embodiments, the mounting base is provided with a first accommodating groove, the limiting piece is arranged in the first accommodating groove, and the first limiting portion is connected to a bottom wall of the first accommodating groove and the second limiting portion, which are spaced apart from each other.

In some possible embodiments, the bottom wall of the first accommodating groove is recessed to form a second accommodating groove, and a number of the second accommodating groove is two, each second accommodating groove is adjacent to the first arc-shaped area of the first limiting portion, the second accommodating groove is provided with a second arc-shaped area adjacent to the first arc-shaped area, and a bending degree of the second arc-shaped area is matched with the bending degree of the first arc-shaped end face.

In some possible embodiments, a bottom wall of the second accommodating groove is recessed to form a third accommodating groove, and the third accommodating groove is used for accommodating part of the reset piece.

In some possible embodiments, the strip-shaped through hole includes a first hole portion and a second hole portion that communicate with each other, the connecting shaft passes through the first hole portion, an aperture of the first hole portion is larger than an aperture of a portion of the second hole portion adjacent to the first hole portion, and the second hole portion penetrates through an end face of the first swing portion away from the second swing portion.

In some possible embodiments, it also includes:
a rotating base, wherein the rotating base is arranged on the bottom wall of the first accommodating groove, and the rotating base is arranged between the two second accommodating grooves; and
a second connecting arm, and a number of the second connecting arm is two, both of which are spaced apart, wherein the second connecting arm is convexly arranged on the key piece relative to the bottom wall of the first accommodating groove, one of the rotating base and the second connecting arm is provided with a rotating shaft, and another one of the rotating base and the second connecting arm is provided with a connecting hole, and the rotating shaft is rotatably arranged in the connecting hole.

In some possible embodiments, it also includes:
a switch assembly, wherein the switch assembly is arranged on the mounting base, the switch assembly is arranged relative to one of the key portions, and the switch assembly is further located beside one of the reset assemblies, so that a switch state of the switch assembly can be switched when one of the key portions is pressed.

In some possible embodiments, an end of the mounting base away from the key piece is provided with at least two terminals;
the switch panel, further comprising:
a junction box, wherein the junction box is arranged away from the key piece, the junction box and the mounting base jointly form a cavity, and the junction box is provided with at least two ports; and
an isolation piece, wherein the isolation piece is connected to the mounting base, the isolation piece is arranged in the cavity, so that the cavity is divided into different sections, at least two of the terminals are exposed to the different sections, and each of the ports is used for inserting a cable to electrically connect to one of the terminals.

Compared with the prior art, the beneficial effects of the present disclosure are:
in the present disclosure, the two reset assemblies cooperate with each other through the swing piece, the connecting shaft, and the reset piece, so that when the swing piece of one of the reset assemblies is horizontally placed, the swing piece of another reset assembly is tilted, thereby reducing the horizontal space occupied by the two reset assemblies and avoiding excessive longitudinal size when two swing pieces are vertically stacked simultaneously. Therefore, the switch panel provided by the present disclosure can improve the balance of size in all directions, thereby enhancing the flexibility of its use.

The present disclosure will be further described in detail below in conjunction with the accompanying drawings and specific embodiments.

### BRIEF DESCRIPTION OF THE DRAWINGS

FIG. 1 is a partial exploded view of a switch panel provided by an embodiment of the present disclosure;

FIG. 2 is a partial structural diagram of a switch panel shown in FIG. 1;

FIG. 3 is a cross-sectional view along V-V in FIG. 2;

FIG. 4 is a schematic structural diagram of the connection between a key piece shown in FIG. 1 and other structural members;

FIG. 5 is a schematic structural diagram of the partial structure shown in FIG. 2 after removing the key piece;

FIG. 6 is a schematic structural diagram of a swing piece shown in FIG. 5; and

FIG. 7 is an enlarged schematic view of the structure of a second accommodating groove, a third accommodating groove and a limiting piece shown in FIG. 5.

### EXPLANATION OF REFERENCE NUMBERS

100—switch panel; 10—mounting base; 11—first base portion; 12—second base portion; 121—first portion; 122—second portion; 101—first accommodating groove; 102—second accommodating groove; 103—third accommodating groove; 1021—second arc-shaped area; 104—window; 105—clamping hole; 20—key piece; 21—key portion; 22—clamping hook; 30—connecting base; 31—first connecting arm; 40—reset assembly; 41—swing piece; 411—first swing portion; 412—second swing portion; 4120—first arc-shaped end face; 413—strip-shaped through hole; 4131—first hole portion; 4132—second hole portion; 42—connecting shaft; 43—reset piece; 50—limiting piece; 51—first limiting portion; 52—second limiting portion; 510—first arc-shaped area; 520—second arc-shaped end face; 60—rotating base; 61—rotating shaft; 70—second connecting arm; 71—connecting hole; 80—switch assembly; 81—trigger portion; 82—circuit element; 90—junction box; 91—isolation piece; and 901—port.

### DETAILED DESCRIPTION OF THE EMBODIMENTS

The technical solutions in the embodiments of the present disclosure will be clearly and completely described below with reference to the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative efforts fall within the scope of protection of the present disclosure.

The terms “first”, “second”, and the like in the specification, the claims, and the accompanying drawings of the present disclosure are used to distinguish different objects rather than to indicate a specific order. Additionally, the terms “comprising” and “being provided with” and any variations thereof are intended to cover non-exclusive inclusion. It should be noted that when an element is referred to as being “fixed to” another element, it can be directly on the other element or intervening elements may also be present. When an element is referred to as being “connected to” another element, it may be directly connected to another element or intervening elements may also be present. When an element is referred to as being “arranged on” another element, it may be arranged on another element or intervening elements may also be present.

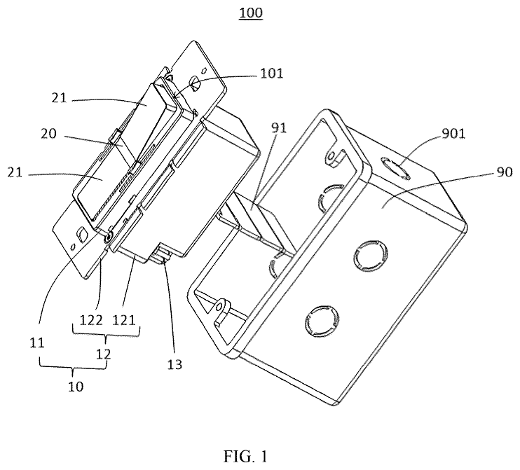

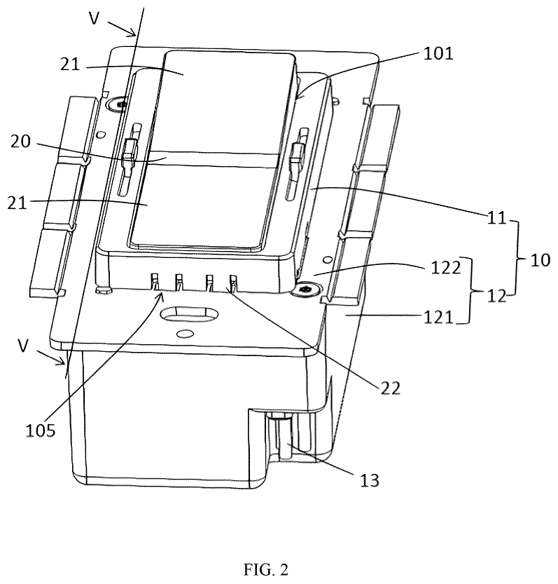

Referring to FIG. 1 to FIG. 5, an embodiment of the present disclosure provides a switch panel 100. The switch panel 100 includes a mounting base 10, a key piece 20, two connecting bases 30, two reset assemblies 40 and two limiting pieces 50.

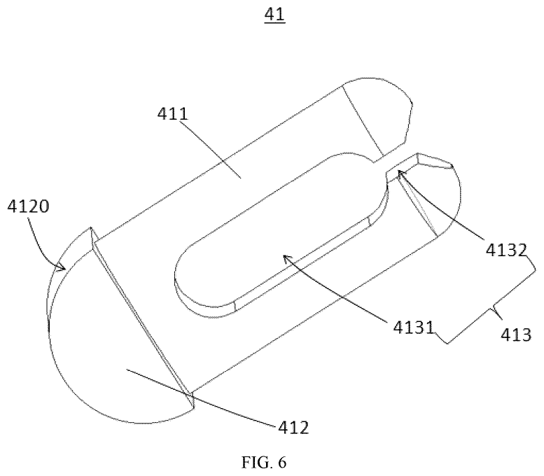

The key piece 20 is provided with a key portion 21, a number of the key portion 21 is two, and the key piece 20 is rotatably connected to the mounting base 10, so that the key portion 21 is arranged to be tilted or lowered relative to another key portion 21. Each connecting base 30 is convexly arranged on one of the two key portions 21 relative to the mounting base 10, and the connecting base 30 includes a first connecting arm 31, and a number of the first connecting arm 31 is two, both of which are arranged spaced apart. The reset assembly 40 includes a swing piece 41, a connecting shaft 42 and a reset piece 43. Referring to FIG. 6, the swing piece 41 includes a first swing portion 411 and a second swing portion 412, the first swing portion 411 is arranged between the two first connecting arms 31, the second swing portion 412 is arranged at an end of the first swing portion 411 away from another reset assembly 40, the first swing portion 411 is provided with a strip-shaped through hole 413 extending towards the second swing portion 412, the connecting shaft 42 rotatably penetrates through the strip-shaped through hole 413 and is connected between the two first connecting arms 31. It can be understood that the connecting shaft 42 can move in the strip-shaped through hole 413. The reset piece 43 is sleeved outside the first swing portion 411, and two ends of the reset piece 43 are pre-compressed to abut against a position between the connecting shaft 42 and the second swing portion 412. For example, the reset piece 43 may be a spring or an elastic sleeve. The limiting piece 50 includes a first limiting portion 51 and a second limiting portion 52; and observed along a rotation direction of the key piece 20, the first limiting portion 51 is connected between the mounting base 10 and the second limiting portion 52, which are spaced apart, to jointly form a limiting space. That is, the limiting space is located on the side of the second limiting portion 52 facing away from the key piece 20. For example, the second limiting portion 52 may be convexly arranged at the top end of the first limiting portion 51. The second swing portion 412 of each reset assembly 40 is rotatably limited in the limiting space.

During specific use, when a key portion 21 is pressed downwards, the connecting base 30 and the connecting shaft 42 cooperate to drive one end of the lower first swing portion 411 away from the second swing portion 412 to rotate downwards. At this time, the limiting space blocks the second swing portion 412 to horizontally move and move upwards to be separated from the limiting space, and at the moment, the reset piece 43 of another reset assembly 40 pre-compresses and accumulates elastic acting force to push the swing portion 41 to rotate upwards, so that another key portion 21 is supported to be tilted. The pressed key portion 21 can be used for triggering the opening state or the closing state of the switch panel 100, and similarly, when the key portion 21 is converted into another key portion 21 which is pressed and tilted, the key piece 20 can be used for triggering the closing state or the opening state of the switch panel 100.

In the present disclosure, the two reset assemblies 40 cooperate with each other through the swing piece 41, the connecting shaft 42, and the reset piece 43, so that when the swing piece 41 of one of the reset assemblies 40 is horizontally placed, the swing piece 41 of another reset assembly 40 is tilted, thereby reducing the horizontal space occupied by the two reset assemblies 40 and avoiding excessive longitudinal size when two swing pieces 41 are vertically stacked simultaneously. Therefore, the switch panel 100 provided by the present disclosure can improve the balance of size in all directions, thereby enhancing the flexibility of its use.

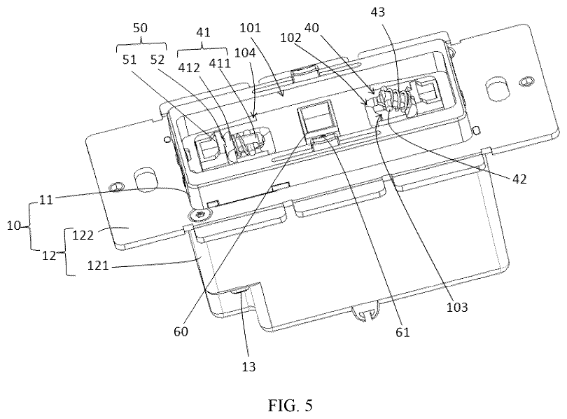

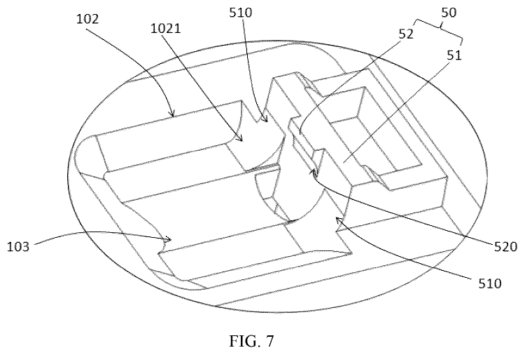

In some embodiments, referring to FIGS. 5 to 7, the second swing portion 412 is provided with a first arc-shaped end face 4120 bent away from the first swing portion 411, an end face of the first limiting portion 51 relative to the limiting space is provided with a first arc-shaped area 510, the first arc-shaped area 510 is adjacent to the mounting base 10, the second limiting portion 52 is provided with a second arc-shaped end face 520 arranged relative to the limiting space, and bending degrees of the first arc-shaped area 510 and the second arc-shaped end face 520 are matched with a bending degree of the first arc-shaped end face 4120, so that the first arc-shaped end face 4120 can rotate along a curved surface jointly formed by the first arc-shaped area 510 and the second arc-shaped end face 520, so that the second swing portion 412 is rotatably limited in the limiting space. The cooperation of the first arc-shaped area 510, the first arc-shaped end face 4120 and the second arc-shaped end face 520 can reduce the friction generated by the rotation of the second swing portion 412, so that the strength of the change-over switch state of the switch panel 100 can be reduced, and the use comfort of the switch panel 100 is improved.

In some embodiments, the first limiting portion 51 is provided with a first arc-shaped area 510, and a number of the first arc-shaped area 510 is two, both of which are arranged spaced apart, and a projection of the second limiting portion 52 is located between the two first arc-shaped areas 510. Reducing the size of the second limiting portion 52 is beneficial for further reducing friction from the second swing portion 412 when it rotates, thereby improving the comfort of using the switch panel 100.

In other embodiments, the number of the first arc-shaped area 510 may be one, and the second arc-shaped end face 520 may be transitionally connected to the first arc-shaped area 510 with equal width.

In some embodiments, the mounting base 10 is provided with a first accommodating groove 101, the limiting piece 50 is arranged in the first accommodating groove 101, the first limiting portion 51 is connected to a bottom wall of the first accommodating groove 101 and the second limiting portion 52, which are spaced apart from each other, and the first accommodating groove 101 is conducive to further reducing the longitudinal volume of the switch panel 100.

In some embodiments, the bottom wall of the first accommodating groove 101 is recessed to form a second accommodating groove 102, and a number of the second accommodating groove 102 is two, each second accommodating groove 102 is adjacent to one of the first arc-shaped areas 510 of the first limiting portion 51, the second accommodating groove 102 is provided with a second arc-shaped area 1021 adjacent to the first arc-shaped area 510, a bending degree of the second arc-shaped area 1021 is matched with the bending degree of the first arc-shaped end face 4120, and the first arc-shaped end face 4120 can rotate along a curved surface jointly formed by the first arc-shaped area 510, the second arc-shaped end face 520 and the second arc-shaped area 1021. The second accommodating groove 102 is conducive to further reducing the longitudinal volume of the switch panel 100.

In some embodiments, a bottom wall of the second accommodating groove 102 is recessed to form a third accommodating groove 103, the third accommodating groove 103 is used for accommodating part of the reset piece 43, the third accommodating groove 103 can extend in a direction away from the second arc-shaped area 1021, and the third accommodating groove 103 can further reduce the longitudinal volume of the switch panel 100.

In some embodiments, referring to FIGS. 5 and 6, the strip-shaped through hole 413 includes a first hole portion 4131 and a second hole portion 4132 that communicate with each other, the connecting shaft 42 passes through the first hole portion 4131, an aperture of the first hole portion 4131 is larger than an aperture of a portion of the second hole portion 4132 adjacent to the first hole portion 4131, and the second hole portion 4132 penetrates through an end face of the first swing portion 411 away from the second swing portion 412. The structure of the strip-shaped through hole 413 is beneficial to ensuring the connection stability of the connecting shaft 42, and meanwhile, irregular breakage caused by stress concentration when the connecting shaft 42 abuts against the strip-shaped through hole 413 when the first swing portion 411 of the swing piece 41 swings is reduced, so that the structure of the strip-shaped through hole 413 is further beneficial to improving the service life of the swing piece 41.

In other embodiments, the strip-shaped through hole 413 may not penetrate through the end face of the first swing portion 411, and the strip-shaped through hole 413 can only include a first hole portion 4131.

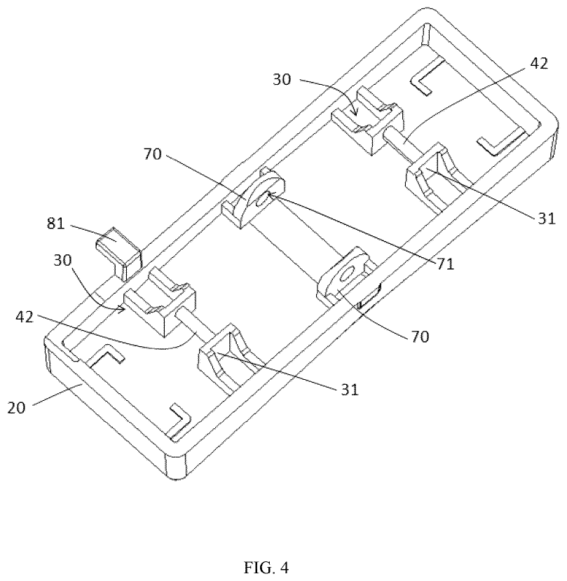

In some embodiments, referring to FIG. 4 and FIG. 5, the switch panel 100 further includes a rotating base 60 and a second connecting arm 70, and a number of the second connecting arm 70 is two, both of which are spaced apart, the rotating base 60 is arranged on the bottom wall of the first accommodating groove 101, and the rotating base 60 is arranged between the two second accommodating grooves 102. The second connecting arm 70 is convexly arranged on the key piece 20 relative to the bottom wall of the first accommodating groove 101. One of the rotating base 60 and the second connecting arm 70 is provided with a rotating shaft 61, and another one of the rotating base 60 and the second connecting arm 70 is provided with a connecting hole 71. In this embodiment, a rotating shaft 61 is arranged on the two end faces, perpendicular to the arrangement direction of the two limiting pieces 50, of the rotating base 60, and each second connecting arm 70 is provided with a connecting hole 71. The rotating shaft 61 is rotatably arranged in the connecting hole 71, so that the key piece 20 is rotatably connected to the mounting base 10. The rotation structure of the present disclosure is relatively simple, and the rotating base 60 is arranged on the bottom wall of the first accommodating groove 101, so that the longitudinal volume of the switch panel 100 is further reduced.

In other embodiments, the key piece 20 can be rotatably connected to the mounting base 10 in a hinged method or a universal ball rotating method.

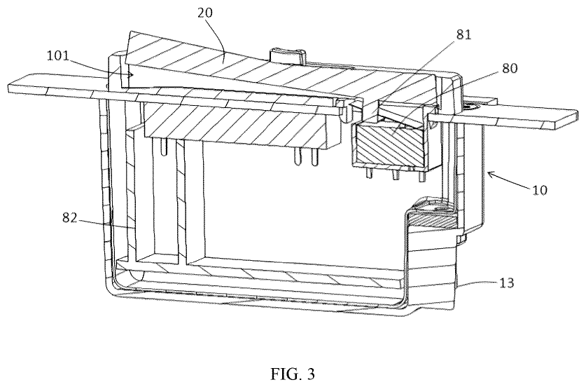

In some embodiments, referring to FIGS. 3 and 5, the switch panel 100 further includes a switch assembly 80, the switch assembly 80 is arranged on the mounting base 10, the switch assembly 80 is arranged relative to one of the key portions 21, and the switch assembly 80 is further located beside one of the reset assemblies 40, so that a switch state of the switch assembly 80 can be switched when one of the key portions is pressed. For example, the switch assembly 80 may include one of a travel switch or a micro switch.

For example, a trigger portion 81 can be arranged on the end face of one of the key portions 21 relative to the mounting base 10. For example, the trigger portion 81 can be of an L-shaped structure, and can press or pull the part of the switch assembly 80 through the trigger portion 81 so as to switch the switch state of the switch assembly 80. In another embodiment, the switch state of the switch assembly 80 can be changed by changing the shape of the end face of the key portion 21 relative to the mounting base 10, for example, setting the shape into a convex curved surface, so that when the key portion 21 is pressed down, the most curved part of the convex curved surface can press the switch assembly 80 to switch the switch state of the switch assembly 80. For example, the switch assembly 80 can be arranged in the mounting base 10, and the switch assembly 80 can be exposed to one side of the mounting base 10 relative to the key piece 20 by means of the window 104. In this embodiment, the window 104 penetrates through the bottom wall of the first accommodating groove 101.

In some embodiments, referring to FIGS. 1 and 5, the mounting base 10 includes a first base portion 11 and a second base portion 12 which are detachably connected, the limiting portion 50 is arranged on the first base portion 11, and correspondingly, the first accommodating groove 101, the second accommodating groove 102 and the third accommodating groove 103 can be arranged on the first base portion 11. The switch assembly 80 can be installed in the second base portion 12. For example, one of the first base portion 11 and the second base portion 12 is provided with a clamping hook 22, the other is provided with a clamping hole 105, and the clamping hook 22 is clamped in the clamping hole 105 to realize detachable connection between the first base portion 11 and the second base portion 12.

In some embodiments, the second base portion 12 includes a first portion 121 and a second portion 122, which are detachably connected. The second portion 122 is arranged closer to the first base portion 11 relative to the first portion 121. For example, the first portion 121 and the second portion 122 can be connected by means of screws. The first portion 121 and the second portion 122, which are connected, can jointly form an accommodating cavity, so that a circuit element 82 can be installed in the accommodating cavity to further enrich the function of the switch panel 100. For example, the circuit element 82 can be electrically connected to the switch assembly 80, so that the conductivity of the circuit element 82 can be switched through the switch assembly 80. For example, the switch panel 100 integrated with the circuit element 82 can have the functions of an electronic doorbell or a dimmer. The structure of the second base portion 12 is conducive to improving the convenience of disassembly and assembly.

In some embodiments, referring to FIG. 1, an end of the mounting base 10 away from the key piece 20 is provided with at least two terminals 13 (two terminals 13 are shown in the figure). For example, the terminal 13 may be electrically connected to the circuit element 82. The switch panel 100 further comprises a junction box 90 and an isolation piece 91. The junction box 90 is arranged away from the key piece 20, the junction box 90 and the mounting base 10 jointly form a cavity, and the junction box 90 is provided with at least two ports 901. For example, the number of the port 901 can be the same as the number of the terminal 13. For example, the port 901 may be an opening or a knock-out hole. The isolation piece 91 is connected to the mounting base 10. For example, the isolation piece 91 is detachably connected to the mounting base 10. For example, the isolation piece 91 can be installed on the mounting base 10 in a snap-fit manner. The isolation piece 91 is arranged in the cavity, so that the cavity is divided into different sections, at least two of the terminals 13 are exposed to the different sections, and each of the ports 901 is used for inserting a cable to electrically connect to one of the terminals 13.

In this embodiment, the terminal 13 may be arranged on the first portion 121.

The above-mentioned embodiments are only preferred embodiments of the present disclosure and cannot be used to limit the scope of protection of the present disclosure. Any non-substantive changes and substitutions made by those skilled in the art on the basis of the present disclosure shall belong to the scope of protection claimed by the present disclosure.

What is claimed is:

1. A switch panel, comprising a mounting base, and further comprising:
a key piece, wherein the key piece is provided with a key portion, a number of the key portion is two, and the key piece is rotatably connected to the mounting base, so that the key portion is arranged to be tilted or lowered relative to another key portion;
a connecting base, a number of the connecting base is two, wherein each connecting base is convexly arranged on one of the two key portions relative to the mounting base, and the connecting base includes a first connecting arm, and a number of the first connecting arm is two, both of which are arranged spaced apart;
a reset assembly, a number of the reset assembly is two, wherein the reset assembly includes a swing piece, a connecting shaft and a reset piece, the swing piece includes a first swing portion and a second swing portion, the first swing portion is arranged between the two first connecting arms, the second swing portion is arranged at an end of the first swing portion away from another reset assembly, the first swing portion is provided with a strip-shaped through hole extending towards the second swing portion, the connecting shaft rotatably penetrates through the strip-shaped through hole and is connected between the two first connecting arms, the reset piece is sleeved outside the first swing portion, and two ends of the reset piece are pre-compressed to abut against a position between the connecting shaft and the second swing portion; and
a limiting piece, a number of the limiting piece is two, wherein the limiting piece includes a first limiting portion and a second limiting portion; and observed along a rotation direction of the key piece, the first limiting portion is connected between the mounting base and the second limiting portion, which are spaced apart, to jointly form a limiting space, and the second swing portion of each reset assembly is rotatably limited in the limiting space.

2. The switch panel according to claim 1, wherein the second swing portion is provided with a first arc-shaped end face bent away from the first swing portion, an end face of the first limiting portion relative to the limiting space is provided with a first arc-shaped area, the first arc-shaped area is adjacent to the mounting base, the second limiting portion is provided with a second arc-shaped end face arranged relative to the limiting space, and bending degrees of the first arc-shaped area and the second arc-shaped end face are matched with a bending degree of the first arc-shaped end face.

3. The switch panel according to claim 2, wherein the first limiting portion is provided with a first arc-shaped area, and a number of the first arc-shaped area is two, both of which are arranged spaced apart, and a projection of the second limiting portion is located between the two first arc-shaped areas.

4. The switch panel according to claim 3, wherein the mounting base is provided with a first accommodating groove, the limiting piece is arranged in the first accommodating groove, and the first limiting portion is connected to a bottom wall of the first accommodating groove and the second limiting portion, which are spaced apart from each other.

5. The switch panel according to claim 4, wherein the bottom wall of the first accommodating groove is recessed to form a second accommodating groove, and a number of the second accommodating groove is two, each second accommodating groove is adjacent to the first arc-shaped area of the first limiting portion, the second accommodating groove is provided with a second arc-shaped area adjacent to the first arc-shaped area, and a bending degree of the second arc-shaped area is matched with the bending degree of the first arc-shaped end face.

6. The switch panel according to claim 5, wherein a bottom wall of the second accommodating groove is recessed to form a third accommodating groove, and the third accommodating groove is used for accommodating part of the reset piece.

7. The switch panel according to claim 1, wherein the strip-shaped through hole includes a first hole portion and a second hole portion that communicate with each other, the connecting shaft passes through the first hole portion, an aperture of the first hole portion is larger than an aperture of a portion of the second hole portion adjacent to the first hole portion, and the second hole portion penetrates through an end face of the first swing portion away from the second swing portion.

8. The switch panel according to claim 5, further comprising:
a rotating base, wherein the rotating base is arranged on the bottom wall of the first accommodating groove, and the rotating base is arranged between the two second accommodating grooves; and
a second connecting arm, and a number of the second connecting arm is two, both of which are spaced apart, wherein the second connecting arm is convexly arranged on the key piece relative to the bottom wall of the first accommodating groove, one of the rotating base and the second connecting arm is provided with a rotating shaft, and another one of the rotating base and the second connecting arm is provided with a connecting hole, and the rotating shaft is rotatably arranged in the connecting hole.

9. The switch panel according to claim 1, further comprising:
a switch assembly, wherein the switch assembly is arranged on the mounting base, the switch assembly is arranged relative to one of the key portions, and the switch assembly is further located beside one of the reset assemblies, so that a switch state of the switch assembly can be switched when one of the key portions is pressed.

10. The switch panel according to claim 9, wherein an end of the mounting base away from the key piece is provided with at least two terminals;
the switch panel, further comprising:
a junction box, wherein the junction box is arranged away from the key piece, the junction box and the mounting base jointly form a cavity, and the junction box is provided with at least two ports; and
an isolation piece, wherein the isolation piece is connected to the mounting base, the isolation piece is arranged in the cavity, so that the cavity is divided into different sections, at least two of the terminals are exposed to the different sections, and each of the ports is used for inserting a cable to electrically connect to one of the terminals.
